(19) United States
(12) Patent Application Publication
(10) Pub. No.: US 2025/0342550 A1
(43) Pub. Date: Nov. 6, 2025

(54) INTERPRETABLE SIMILARITY BASED METHOD AND SYSTEM FOR AIRPORT SURFACE TAXI TIME PREDICTION

(71) Applicant: Nanjing University of Aeronautics and Astronautics, Nanjing (CN)

(72) Inventors: Jianan Yin, Nanjing (CN); Peiran Qiao, Nanjing (CN); Hua Xie, Nanjing (CN); Minghua Hu, Nanjing (CN); Wen Tian, Nanjing (CN); Yuxuan He, Nanjing (CN); Wei Wu, Nanjing (CN)

(73) Assignee: Nanjing University of Aeronautics and Astronautics, Nanjing (CN)

(21) Appl. No.: 19/264,500

(22) Filed: Jul. 9, 2025

(30) Foreign Application Priority Data
Jul. 11, 2024 (CN) 202410928836.1

(51) Int. Cl. G06Q 50/40; G06N 3/045; G06N 3/0464

(52) U.S. Cl. CPC G06Q 50/40; G06N 3/045; G06N 3/0464

(57) ABSTRACT

The invention discloses an interpretable similarity based method and system for airport surface taxi time prediction. The method comprises the following steps: Step 1, collecting airport scenario data from an A-CDM system and airport weather data from an aviation meteorological department, and constructing a candidate scenario database; Step 2, extracting the feature related to taxi time and classifying according to whether the data has a periodic property, dividing the result into a static feature similarity of taxi scenario and a periodic feature similarity of taxi scenario, and carrying out a data construction, respectively; Step 3, calculating the taxi time according to the dynamic interpretable similarity, calculating the scenario similarity between a target scenario and the candidate similar scenario according to the static feature and the periodic feature, and performing a weighted sum to obtain an integrated scenario similarity, according to the obtained scenario similarity, weighting a taxi time of all candidate scenarios to linearly generate a taxi time prediction result in the target scenario. The invention realizes the linear generation of taxi time and improves the prediction accuracy of the model.

### TECHNICAL FIELD

The invention belongs to the field of key index prediction of airport surface, especially relates to a taxi time prediction method which is suitable for the static attribute features that are not changed with time and the dynamic attribute features of flights with periodic features.

### BACKGROUND

In order to improve the operation efficiency of air transport airports, requirements are put forward for the fine deployment of the surface with the continuous improvement of flight volume. In large transport airports, the surface structure is coupled with each other and has the features of complex structure, dense traffic and changeable environment, which makes it difficult for controllers to make decisions in the actual operation process, especially in the peak period of the airport. The airport collaborative decision-making (A-CDM) system is generally used in the current surface operation management. The system realizes the allocation of airport resources by encouraging multiple parties to implement collaborative cooperation, and ultimately improves the operational efficiency of the airport network. By 2023, the A-CDM system has been constructed and used at 33 airports in Europe. Among them, variable taxi time (VTT) is a key indicator in the use of A-CDM system for surface scheduling, when the taxi time cannot be accurately estimated, it will cause waste of surface resources and environmental pollution problems.

As the design of the prediction model becomes more and more complex, the prediction accuracy of the taxi time is also getting higher and higher. However, due to the opacity of the taxi time prediction process, the controller cannot fully understand the working principle of the model in the actual surface control work, which makes the controller more inclined to their own experience in order to ensure the safety of operation, thus hindering the promotion of related technologies. In order to improve the controller's trust in the taxi time prediction model, a feasible solution is to adopt a prediction model based on similar scenarios, by comparing the difference between the actual operation information of the historical scenario and the current scenario, the historical statistical results for the target scenario are provided. In the field of taxi time prediction, multiple historical taxiing data most similar to the current scenario are used to improve the taxi time prediction accuracy of departure aircraft in the target scenario. Considering that the scenarios obtained by such methods are based on actual historical operation data and are completely visible, the prediction results will be more easily accepted by front-line operators, so the process is considered to be interpretable. Therefore, a taxi time prediction method that can provide more historical reference information is urgently needed in the current field.

### SUMMARY

The purpose of this invention is to provide an interpretable similarity based method and system for airport surface taxi time prediction, according to the heterogeneous feature types, the multi-time scale comparison is carried out to calculate the interpretable similarity of the surface and linearly generate the taxi time prediction results, thereby fulfilling accurate surface control.

In order to achieve the above purpose, the invention adopts the following technical scheme:

An interpretable similarity based method for airport surface taxi time prediction, including the following steps:

Step 1, surface original data processing, collecting airport scenario data from an A-CDM system and airport weather data from an aviation meteorological department, preprocessing the obtained data to obtain a complete data list without missing items in line with an actual operation, and constructing a candidate scenario database.

Step 2, establishing a surface taxi scenario feature system, starting from flight model data, flight plan data, surface situation data and airport environment data, extracting a feature related to taxi time and classifying according to whether the data has a periodic property, dividing a result into a static feature similarity of taxi scenario and a periodic feature similarity of taxi scenario, and carrying out a data construction, respectively.

Step 3, dynamic similarity calculation and taxi time prediction, calculating a taxi time according to the dynamic interpretable similarity, calculating a scenario similarity between a target scenario and the candidate similar scenario according to the static feature and the periodic feature, and performing a weighted sum to obtain an integrated scenario similarity, according to the obtained scenario similarity, weighting a taxi time of all candidate scenarios to linearly generate a taxi time prediction result in the target scenario.

Step 1 specifically includes:

(1.1) Collecting collaborative decision-making data from the airport A-CDM system, flight plan data from airlines, and meteorological message data from the airport meteorological department, and matching the data involved in all flight scenarios.

(1.2) Preprocessing matched data, removing all erroneous data, completing missing data, screening out all abnormal data, and constructing an original scenario database.

Step 2 includes:

(2.1) Based on an original data set of the taxi scenario generated by screening, extracting static attribute features of the taxi scenario, the static attribute features of taxi scenario include eight common features, namely flight number, airline, runway apron group, parking space, aircraft type, destination airport, hour and minute, a taxiing trajectory is reflected by the pairing of runway and parking space, the above eight features are classified features, so an entity embedding method is introduced for recoding, constructing a neural network with a taxi time in different scenarios as a supervision condition, and adding an additional embedding layer to the network, embedding classification features in all samples into half of an original dimension.

(2.2) The content reflected by the periodic attribute features of the taxi scenario is an interaction relationship between a departure flight and other departure or arrival flight and the weather, four types of eight surface traffic features based on a spatio-temporal network topology are adopted, which comprehensively considers a possible relationship between departure flights and arrival flights, the departure/arrival surface instantaneous flow index (SIFI) denotes a count of arrival or departure aircrafts that are taxiing when the target aircraft is launched; the departure/arrival surface cumulative flow index (SCFI) denotes a count of departure and arrival aircrafts that are also in a taxiing state when the target aircraft taxis, the aircraft queue length index (AQLI) denotes a total number of the aircraft taking off or landing during the taxiing of the target aircraft; the slot resource demand index (SRDI) is used to represent a total number of aircraft launched or landed within 15 minutes before and after a launch time of the target aircraft.

(2.3) Constructing a data structure required by an input network, according to the features of the two types of data, in the construction of the static attribute feature data structure of the taxi scenario, a vector for data embedding processing is called the static attribute vector gᵢ, and all the sample target scenarios are stacked with their respective candidate similar scenario sets for input structure construction, the final input data format is s×n×2×α_{cat}, where S denotes a count of sample scenarios, α_{cat} is a dimension of the static attribute vector after processing, and n is a count of candidate scenarios, the flight static attributes of all sample target scenarios are compared with those of each candidate similar scenario in this type of construction, the above attributes are only related to the flight plan or the airport and weather data and have nothing to do with the actual state of the airport surface.

(2.4) In terms of the periodic attribute features of taxi scenarios, considering that an arrangement of flight schedules may have periodic features, splicing the dynamic attribute features of the environment also of the first day, the first 7 days and the first 28 days of all scenarios to form a multi-time scale environment dynamic attribute input vector under one day, which is called dynamic attribute vector gₑ, and all scenario data is processed according to the above steps, all scenarios are combined with their respective candidate similar scenario sets, and finally the input data is formed.

In Step (2.2), the estimated launch time and planned take-off time are used in the calculation of these features, taking into account post-launch and tactical operations.

Step 3 specifically includes:

(3.1) Scenario index decomposition, for the taxi time T(n) in the n-th candidate similar scenario, the deviation δₙ between the taxi time T_{ξ} of the target scenario ξ and the deviation between the first candidate similar scenario and the target scenario is used for representation, therefore, the following method is used to model and analyze the composition of the departure taxi time of the candidate similar scenario:

$$T ( n ) = {T}_{ξ} + {δ}_{n}$$

The various influencing factors and uncertainties involved in the surface will lead to the shortening or prolongation of the taxi time in the current scenario compared with the target scenario, therefore, in order to facilitate the analysis, the taxi time deviation in the n-th candidate scenario is subject to the normal distribution of the mean value of 0, so δₙ □N(0,

$${σ}_{n}^{2} ) ,$$

where

$${σ}_{n}^{2}$$

is the variance due to the key feature difference between the target scenario and it under the condition of the scenario.

(3.2) Suppose there are only two different departure flight operation scenarios i and j in a scenario, the taxi time is rewritten as T(i) □Nᵢ(T_{ξ},

$${σ}_{i}^{2} ) ,$$

and the other sample is rewritten as T(j) □Nⱼ(T_{ξ},

$${σ}_{j}^{2} ) .$$

Multiple samples with the same mean but different variances are used for combination, and weights are applied to minimize the overall variance to obtain a more accurate value T_{ξ}:

$${T}_{ξ}^{E} = {ω}_{i} {N}_{i} + {ω}_{j} {N}_{j}$$

Where ω is the scenario similarity,

$${T}_{ξ}^{E}$$

is an estimated value of the target scenario taxi time, the sum of the similarities is limited to ωᵢ+ωⱼ=1.

(3.3) The variance of T_{ξ} is

$$D ( {T}_{ξ}^{E} )$$

according to statistical knowledge, and:

$$D ( {T}_{ξ}^{E} ) = {ω}_{i}^{2} {σ}_{i}^{2} + {ω}_{j}^{2} {σ}_{j}^{2} = {ω}_{i}^{2} {σ}_{i}^{2} + {( 1 - {ω}_{i} )}^{2} {σ}_{j}^{2}$$

The similarities in the formula are derived to obtain:

$$\frac{d ( D ( {T}_{ξ}^{E} ) )}{d {ω}_{i}} = 2 {ω}_{i} ( {σ}_{i}^{2} + {σ}_{j}^{2} ) - 2 {σ}_{j}^{2}$$

$$\frac{{d}^{2} ( D ( {T}_{ξ}^{E} ) )}{d {ω}_{i}^{2}} = 2 {ω}_{i} ( {σ}_{i}^{2} + {σ}_{j}^{2} )$$

Obviously, a value of a second derivative is greater than zero, so a minimum value of the variance is obtained, and corresponding similarities are:

$${ω}_{i} = \frac{{σ}_{j}^{2}}{{σ}_{i}^{2} + {σ}_{j}^{2}}$$

$${ω}_{j} = \frac{{σ}_{i}^{2}}{{σ}_{i}^{2} + {σ}_{j}^{2}}$$

If the corresponding similarities of multiple scenarios are determined, the expression is as follows:

$${ω}_{j} = \frac{{\prod }_{k ∈ S - i} {σ}_{k}^{2}}{{{\sum }_{l = 1}}^{n} {\prod }_{o ∈ S - l} {σ}_{o}^{2}}$$

Where S is a set of scenarios, including n different scenarios, so the following results are obtained:

$${T}_{ξ}^{E} = {\sum }_{i ∈ S} {ω}_{i} {N}_{i}$$

Where a sum of all similarities is 1, that is,

$${\sum }_{i ∈ S} {ω}_{i} = 1 ;$$

(3.4) Also considering a sample variance is a minimum value, combined with a final prediction result, it is approximately considered that the taxi time of the target scenario is a weighted sum of the samples, and it is expressed as:

$${T}_{ξ} = {\sum }_{i ∈ S} {ω}_{i} T ( i )$$

likewise, a similarity sum is 1, that is,

$${\sum }_{i ∈ S} {ω}_{i} = 1 ,$$

where each weight ωᵢ is the interpretable similarity of the scenario.

Based on the features of interpretable similarity, the processed two types of data are input into two neural networks NET1 and NET2 respectively, the calculation process is as follows:

(3.5) Data downsampling visualization, using a convolution kernel to downsample the data; expanding the simplified data to form a two-dimensional tensor, the size and shape are similar to those of common pictures.

(3.6) Class image convolution, using a LeNet-based network framework structure to perform convolution pooling on a tensor, connecting the fully connected layers to the ends of the two neural networks to obtain their similarity vectors, and combining the weights to obtain a similarity fitting result of n×1, the number is consistent with the number of candidate similar scenarios, wherein a loss function is calculated as follows:

$$ω = {arg min}_{{ω}_{mn}} ( \frac{1}{K} {\sum }_{{x}_{m}^{ξ} ∈ α} {( {\sum }_{{x}_{n} ∈ β} {ω}_{m n} T ( {x}_{n} ) - T ( {x}_{m}^{ξ} ) )}^{2} + λ {\sum }_{{x}_{m}^{ξ} ∈ α} {\sum }_{{x}_{n} ∈ β} {{ω}_{m n} ( T ( {x}_{n} ) - T ( {x}_{m}^{ξ} ) )}^{2} )$$

where ω is a similarity set of candidate similar scenarios in all target scenarios, ωₘₙ is the similarity of the n-th scenario in the m-th target scenario, the meaning of xₘ^{ξ} is the m-th target scenario feature, the meaning of xₙ is the n-th historical scenario feature, α is the target scenario set, β is the candidate similar scenario set, λ is a deviation importance parameter, K is the count of target running scenarios for all departure aircraft in the training process, T(xₙ) is the taxi time of the n-th candidate similar scenario, and

$$T ( {x}_{m}^{ξ} )$$

is an actual taxi time in the target scenario

$${x}_{m}^{ξ} ;$$

the loss function is composed of two parts, which minimizes the taxi time prediction error on the training set and reduces the similarity value of the high deviation scenario also the actual function of the neural network in this process is to calculate the similarity between different scenarios and the target scenario and use it to linearly generate the taxi time of the departure flight in the target scenario.

(3.7) Prior processing, finally, in order to ensure that the similarity sum is 1, the following conditions are required:

$${\sum }_{n ∈ N} {ω}_{n} = 1 ω \geq 0 ;$$

based on this constraint, it is necessary to perform additional prior processing on the similarity of the outputs in the two neural networks, firstly, all the negative similarities of the outputs need to be mapped to 0, that is, adding an additional ReLU layer at the end of the two neural networks; secondly, the ownership weight needs to be normalized, that is, adding a normalized layer after the ReLU layer of the two neural networks, combined weighting and outputting the above similarity to generate the overall similarity between the target scenario and the candidate similar scenario, the calculation method is as follows

$$μ {\sum }_{n ∈ N} {ω}_{n}^{n e t 1} + ( 1 - μ ) {\sum }_{n ∈ N} {ω}_{n}^{n e t 2} = 1 , ω \geq 0$$

where μ is a combination similarity distribution coefficient,

$${ω}_{n}^{net 1} and {ω}_{n}^{net 2}$$

are the static and dynamic vector similarities of the candidate similar scenarios output by NET1 and NET2 in the n-th sample target scenario respectively.

(3.8) Iterative training and similarity extraction, by linearly generating the taxi time, linearly weighting and summing the predicted combined similarity and the historical taxi time in the candidate similar scenario, and performing an iterative training according to the loss function to reduce the error between the combined similarity and the historical taxi time.

(3.9) According to the calculation results of scenario similarity, weighting and summing the taxi time of the corresponding flight in each candidate similar scenario, and the result is used to represent the taxi time result in the target scenario.

An interpretable similarity based system for airport surface taxi time prediction is proposed, including:

An airport surface flight taxi scenario data processing module, the airport surface flight taxi scenario data processing module is used to collect and preprocess data from multiple data sources.

A surface flight taxi scenario feature extraction and grouping module, the surface flight taxi scenario feature extraction and grouping module extracts features according to whether the data has periodic features, and divides the results into static attribute features of taxi scenario and periodic attribute features of taxi scenario.

A surface dynamic interpretable similarity calculation and taxi time prediction module, the surface dynamic interpretable similarity calculation and taxi time prediction module is used to input data integration and calculate the dynamic interpretable similarity between the target scenario and the historical running scenario.

Beneficial effect: The interpretable similarity based method and system for airport surface taxi time prediction of the invention designed an interpretable similarity based process and system for taxi time prediction, according to the features of the characteristic data, the static features and the periodic features are compared respectively, the data provides a new method for realizing accurate taxi time prediction, which can provide strong support for subsequent decision-making content such as aircraft launch control, and fills the technical gaps in the calculation method of dynamic interpretable similarity of airport surface operation and taxi time prediction.

### BRIEF DESCRIPTION OF THE DRAWINGS

FIG. 1 is a hierarchical division diagram of the interpretable similarity based method for airport surface taxi time prediction;

FIG. 2 is a core flow chart of the interpretable similarity based method for airport surface taxi time prediction;

FIG. 3 is a static attribute feature data structure of taxi scenario of the interpretable similarity based method for airport surface taxi time prediction;

FIG. 4 is a periodic attribute feature data structure of taxi scenario of the interpretable similarity based method for airport surface taxi time prediction;

FIG. 5 is a neural network structural diagram of the interpretable similarity based method for airport surface taxi time prediction.

FIG. 6 is a comparison chart of the prediction accuracy obtained by the interpretable similarity based method for airport surface taxi time prediction.

FIG. 7 is a weight distribution map obtained by the interpretable similarity based method for airport surface taxi time prediction.

### DETAILED DESCRIPTION OF THE EMBODIMENTS

In order to make the design purpose, improvement measures and combination advantages of the invention easy to understand, this method is further explained in detail by combining the following seven charts and implementation examples. also it is also necessary to state that the surface classification samples used in this section are only used to illustrate the feasibility of the classification method, and are not uniquely applicable to the process included in the invention.

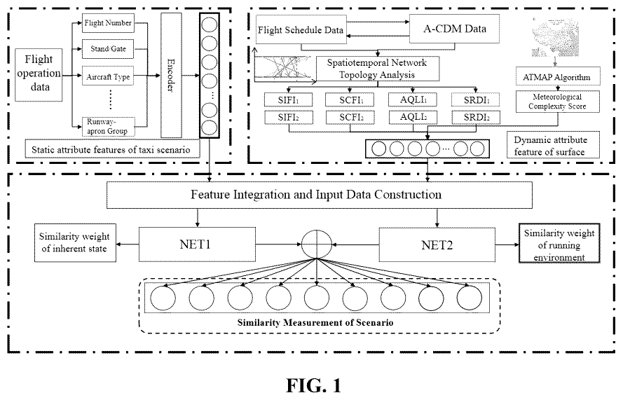

FIG. 1 is the hierarchical division diagram of the interpretable similarity based method for airport surface taxi time prediction, it explains the whole process of the invention from data processing to data construction to taxi time prediction, and summarizes the overall implementation scheme of the invention.

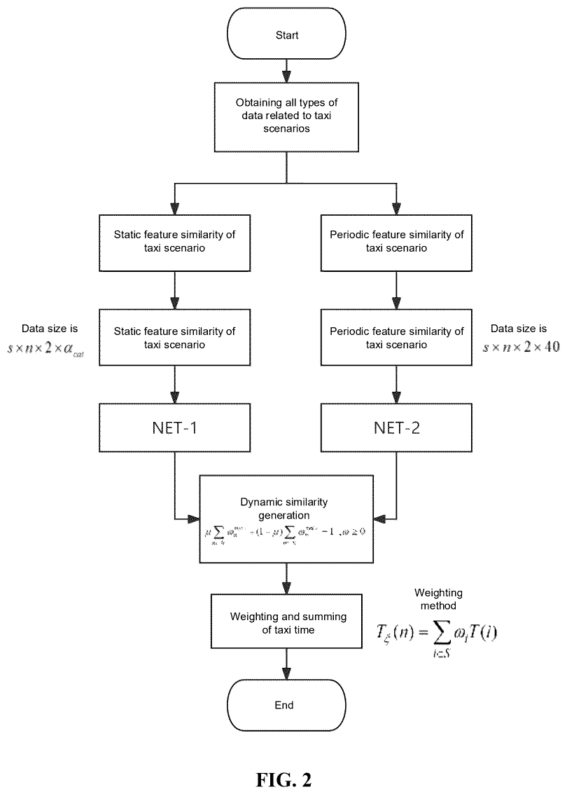

FIG. 2 is the core flow chart of the interpretable similarity based method for airport surface taxi time prediction, the implementation order and specific implementation method of each step in the invention are described in detail.

The interpretable similarity based method for airport surface taxi time prediction, including the following steps:

Step 1: scenario data collection and preprocessing, the essence of which is data cleaning and integration. The relevant data in the scenario is collected and matched and the data with errors and omissions is processed, including the following steps:

(1.1) the collaborative decision-making data from the airport A-CDM system, flight plan data from airlines, and meteorological message data from the airport meteorological department, etc. is collected. The data involved in all flight scenarios is match.

(1.2) the matched data is preprocessed, all erroneous data is removed, the missing data is completed, all abnormal data are screened, and the original scenario database is constructed.

Statistics of various scenario data within the target time range in the busy airport included but are not limited to airport A-CDM data, flight plan data submitted by airlines, meteorological message time of the airport, etc. The error data is directly deleted, and the missing data is filled by difference filling or upward filling. The cleaned original data is integrated to form the original departure flight scenario database.

Step 2: feature processing and data construction. The essence is to extract the features of the processed data according to the features of the data. The feature is divided into the static attribute feature of the taxi scenario and the periodic attribute feature of the taxi scenario, and the input data is constructed according to the features of the similar scenario, which includes the following steps:

(2.1) Based on the original data set of the taxi scenario generated by screening, the static attribute features of the taxi scenario are extracted, which referred to the features determined by the flight type and the location of the flight, including flight number, airline, type and parking space. The invention introduced a total of 8 common features, namely flight number, airline, runway apron group, parking space, aircraft type, destination airport, hour and minute, a taxiing trajectory is reflected by the pairing of runway and parking space. The above 8 features are classified features, so the entity embedding method is introduced for recoding. The invention used the taxi time in different scenarios as a supervisory condition to construct a neural network, and an additional embedding layer is added to the network, and the classification features in all samples are embedded into the space of half of the original dimension, the invention can significantly reduce the cost of the prediction model.

(2.2) The main content reflected by the periodic attribute features of the taxi scenario is an interaction relationship between the departure flight and other departure or arrival flight and the weather, 4 types of 8 surface traffic features based on the spatio-temporal network topology are adopted, which comprehensively considered the possible relationship between departure flights and arrival flights, the departure/arrival surface instantaneous flow index (SIFI) denotes the count of arrival or departure aircrafts that are taxiing when the target aircraft is launched; the departure/arrival surface cumulative flow index (SCFI) denotes the count of departure and arrival aircrafts that are also in the taxiing state when the target aircraft taxis, the aircraft queue length index (AQLI) denotes a total number of the aircraft taking off or landing during the taxiing of the target aircraft; the slot resource demand index (SRDI) is used to represent a total number of aircraft launched or landed within 15 minutes before and after a launch time of the target aircraft; it should be noted that considering the late and tactical operations, the expected launch time and planned take-off time are used when calculating these features.

(2.3) The data structure required by the input network is constructed, according to the features of the two types of data, in the construction of the static attribute feature data structure of the taxi scenario, the vector for data embedding is called the static attribute vector gᵢ, and all the sample target scenarios are stacked with their respective candidate similar scenario sets for input structure construction, the final input data format is s×n×2×α_{cat}, where S denotes a count of sample scenarios, α_{cat} is a dimension of the static attribute vector after processing, and n is a count of candidate scenarios. The flight static attributes of all sample target scenarios are compared with those of each candidate similar scenario in this type of construction. The above attributes are only related to the flight plan or the airport and weather data and have nothing to do with the actual state of the airport surface.

(2.4) In terms of the periodic attribute features of taxi scenarios, considering that the arrangement of flight schedules may have periodic features, the dynamic attribute features of the environment also of the first day, the first 7 days and the first 28 days of all scenarios are spliced to form a multi-time scale environment dynamic attribute input vector under one day, which is called dynamic attribute vector gₑ, and all scenario data is processed according to the above steps. All scenarios are combined with their respective candidate similar scenario sets, and finally the input data is formed.

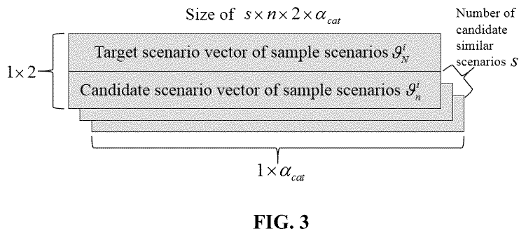

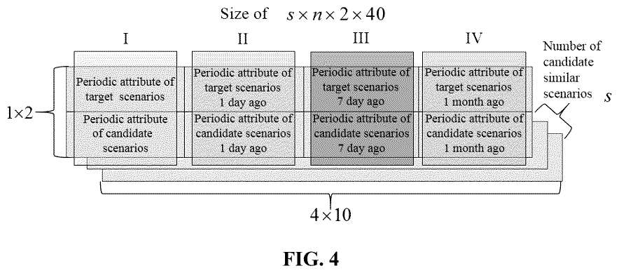

The features related to the taxi time are extracted and classified according to the static attribute features of the taxi scenario and the periodic attribute features of the taxi scenario. The contents such as flight number and model are extracted from the static attribute features of the surface, and the features such as surface congestion evaluation index and airport weather state are extracted from the periodic attribute features of the taxi scenario. Entity embedding is performed on the categorical variables. The two features are matched and stored separately. The construction results are shown in FIG. 3 and FIG. 4.

Step 3: scenario dynamic interpretable similarity calculation and taxi time prediction. The essence is to perform similarity fusion based on the calculation results of the similarity between the target scenario and the candidate scenario in the neural network proposed in this method, and finally generate the scenario interpretable similarity. Finally, the interpretable similarity of the candidate scenario and the aircraft taxi time in the scenario are weighted and summed to obtain the taxi time prediction result in the target scene, the specific steps are as follows:

(3.1) scenario index decomposition, for the taxi time T(n) in the n-th candidate similar scenario, the deviation δₙ between the taxi time T_{ξ} of the target scenario ξ and the deviation between the first candidate similar scenario and the target scenario is used for representation. Therefore, the following method is used to model and analyze the composition of the departure taxi time of the candidate similar scenario:

$$T ( n ) = {T}_{ξ} + {δ}_{n}$$

The various influencing factors and uncertainties involved in the surface would lead to the shortening or prolongation of the taxi time in the current scenario compared with the target scenario, therefore, in order to facilitate the analysis, the taxi time deviation in the n-th candidate scenario is subject to the normal distribution of the mean value of 0, δₙ□N(0,

$${σ}_{n}^{2} ) ,$$

where

$${σ}_{n}^{2}$$

is the variance due to the key feature difference between the target scenario and it under the condition of the scenario.

(3.2) Suppose there are only two different departure flight operation scenarios i and j in a scenario, the taxi time is rewritten as T(i) □Nᵢ(T_{ξ},

$${σ}_{i}^{2} ) ,$$

and the other sample is rewritten as T(j) □Nⱼ(T_{ξ},

$${σ}_{j}^{2} ) ;$$

multiple samples with the same mean but different variances are used for combination, and the weights are applied to minimize the overall variance to obtain a more accurate value T_{ξ}:

$${T}_{ξ}^{E} = {ω}_{i} {N}_{i} + {ω}_{j} {N}_{j}$$

where ω is the scenario similarity,

$${T}_{ξ}^{E}$$

is the estimated value of the target scenario taxi time, the sum of the similarities is limited to ωᵢ+ωⱼ=1.

(3.3) The variance of T_{ξ} is

$$D ( {T}_{ξ}^{E} )$$

according to statistical knowledge, and:

$$D ( {T}_{ξ}^{E} ) = {ω}_{i}^{2} {σ}_{i}^{2} + {ω}_{j}^{2} {σ}_{j}^{2} = {ω}_{i}^{2} {σ}_{i}^{2} + {( 1 - {ω}_{i} )}^{2} {σ}_{j}^{2}$$

the similarities in the formula are derived to obtain:

$$\frac{d ( D ( {T}_{ξ}^{E} ) )}{d {ω}_{i}} = 2 {ω}_{i} ( {σ}_{i}^{2} + {σ}_{j}^{2} ) - 2 {σ}_{j}^{2}$$

$$\frac{{d}^{2} ( D ( {T}_{ξ}^{E} ) )}{d {ω}_{i}^{2}} = 2 {ω}_{i} ( {σ}_{i}^{2} + {σ}_{j}^{2} )$$

Obviously, the value of the second derivative is greater than zero, so the minimum value of the variance is obtained, and corresponding similarities are:

$${ω}_{i} = \frac{{σ}_{j}^{2}}{{σ}_{i}^{2} + {σ}_{j}^{2}}$$

$${ω}_{j} = \frac{{σ}_{i}^{2}}{{σ}_{i}^{2} + {σ}_{j}^{2}}$$

if the corresponding similarities of multiple scenarios are determined, the expression is as follows:

$${ω}_{i} = \frac{{\prod }_{k ∈ S - i} {σ}_{k}^{2}}{{\sum }_{l = 1}^{n} {\prod }_{o ∈ S - l} {σ}_{o}^{2}}$$

where S is the set of scenarios, including n different scenarios. Therefore, the following results are obtained:

$${T}_{ξ}^{E} = {\sum }_{i ∈ S} {ω}_{i} {N}_{i}$$

where the sum of all similarities is 1, that is,

$${\sum }_{i ∈ S} {ω}_{i} = 1 ;$$

(3.4) also considering the sample variance is a minimum value, combined with a final prediction result, it is approximately considered that the taxi time of the target scenario is a weighted sum of the samples, and it is expressed as:

$${T}_{ξ} = {\sum }_{i ∈ S} {ω}_{i} T ( i )$$

likewise, the similarity sum is 1, that is

$${\sum }_{i ∈ S} {ω}_{i} = 1 ,$$

where each weight ωᵢ is the interpretable similarity of the scenario; based on the features of interpretable similarity, the processed two types of data are input into two neural networks NET1 and NET2 respectively, the calculation process is as follows:

(3.5) Data downsampling visualization, a convolution kernel is used to downsample the data; the simplified data is expanded to form a two-dimensional tensor, the size and shape are similar to those of common pictures.

(3.6) Class image convolution, the LeNet-based network framework structure is used to perform convolution pooling on a tensor. The fully connected layers are connected to the ends of the two neural networks to obtain their similarity vectors, and the weights are combined to obtain a similarity fitting result of n×1, the number is consistent with the number of candidate similar scenarios. Wherein the loss function is calculated as follows:

$$ω = {arg min}_{{ω}_{min}} ( {\frac{1}{K} {\sum }_{{x}_{m}^{ξ} ∈ α} ( {\sum }_{{x}_{n} ∈ β} {ω}_{m n} T ( {x}_{n} ) - T ( {x}_{m}^{ξ} ) )}^{2} + λ {\sum }_{{x}_{m}^{ξ} ∈ α} {\sum }_{{x}_{n} ∈ β} {{ω}_{m n} ( T ( {x}_{n} ) - T ( {x}_{m}^{ξ} ) )}^{2} )$$

where ω is a similarity set of candidate similar scenarios in all target scenarios, ωₘₙ is the similarity of the n-th scenario in the m-th target scenario, the meaning of

$${x}_{m}^{ξ}$$

is the m-th target scenario feature, the meaning of xₙ is the n-th historical scenario feature, α is the target scenario set, β is the candidate similar scenario set, λ is a deviation importance parameter, K is the count of target running scenarios for all departure aircraft in the training process, T(xₙ) is the taxi time of the n-th candidate similar scenario, and

$$T ( {x}_{m}^{ξ} )$$

is an actual taxi time in the target scenario

$${x}_{m}^{ξ} .$$

The loss function is composed of two parts, which minimizes the taxi time prediction error on the training set and reduces the similarity value of the high deviation scenario also the actual function of the neural network in this process is to calculate the similarity between different scenarios and the target scenario and use it to linearly generate the taxi time of the departure flight in the target scenario.

(3.7) Prior processing, finally, in order to ensure that the similarity sum is 1, the following conditions are required:

$${\sum }_{n ∈ N} {ω}_{n} = 1 \qquad ω \geq 0 ;$$

based on this constraint, it is necessary to perform an additional prior processing on the similarity of the outputs in the two neural networks, firstly, all the negative similarities of the outputs needed to be mapped to 0, that is, an additional ReLU layer is added at the end of the two neural networks; secondly, the ownership weight needed to be normalized, that is, a normalized layer is added after the ReLU layer of the two neural networks. The above similarity is combined weighed and output to generate the overall similarity between the target scenario and the candidate similar scenario, the calculation method is as follows:

$$μ {\sum }_{n ∈ N} {ω}_{n}^{net 1} + ( 1 - μ ) {\sum }_{n ∈ N} {ω}_{n}^{net 2} = 1 , \qquad ω \geq 0$$

where μ is a combination similarity distribution coefficient,

$${ω}_{n}^{net 1} and {ω}_{n}^{net 2}$$

are the static and dynamic vector similarities of the candidate similar scenarios output by NET1 and NET2 in the n-th sample target scenario respectively. This method can significantly reduce the parameter search space and accelerate the convergence of the neural network.

(3.8) Iterative training and similarity extraction, by linearly generating the taxi time, the predicted combined similarity and the historical taxi time in the candidate similar scenario are linearly trained and summed, and an iterative training is performed according to the loss function to reduce the error between the combined similarity and the historical taxi time.

(3.9) According to the calculation results of scenario similarity, the taxi time of the corresponding flight in each candidate similar scenario is weighted and summed, and the result is used to represent the taxi time result in the target scenario.

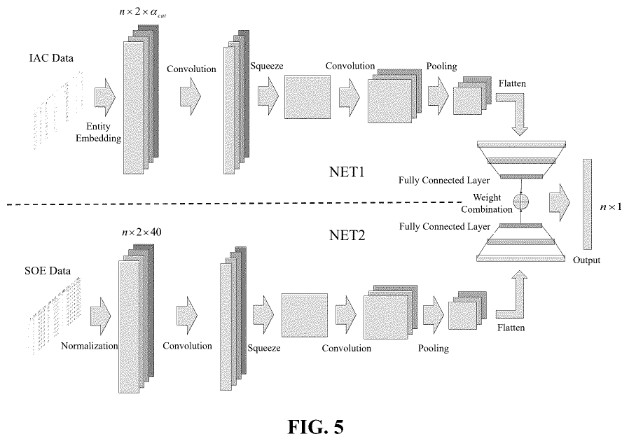

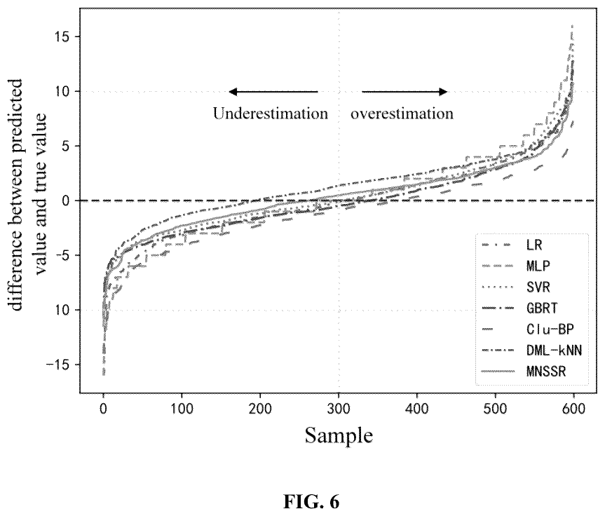

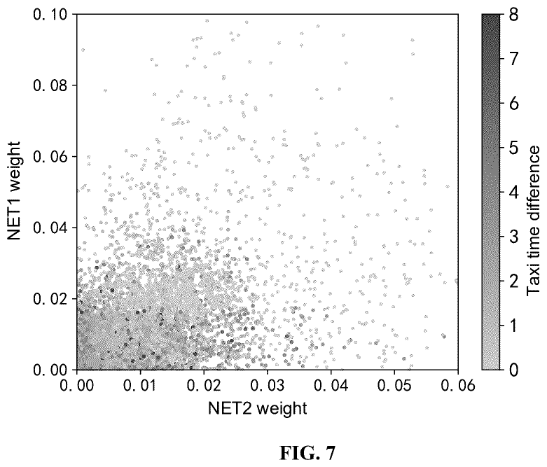

The scenario data in Step 2 is used to train the parameters in the taxi time prediction network proposed by the invention. The network structure is shown in FIG. 5. The scene similarity between the static attribute features of the taxi scenario and the periodic attribute features of the taxi scenario is compared. Finally, the similarity between the target scenario and all candidate similar scenarios is evaluated according to the fully connected layer and the scenario metric vector after prior processing. The obtained dynamic similarity is weighted with the taxi time in the candidate taxi scenario to obtain the taxi time prediction result in the target scenario. The prediction accuracy is shown in FIG. 6, and the weight distribution is shown in FIG. 7.

This implementation example also provides an interpretable similarity based system for airport surface taxi time prediction is proposed, including:

An airport surface flight taxi scenario data processing module, the airport surface flight taxi scenario data processing module is used to collect and preprocess data from multiple data sources.

A surface flight taxi scenario feature extraction and grouping module, the surface flight taxi scenario feature extraction and grouping module extracts features according to whether the data has periodic features, and divides the results into static attribute features of taxi scenario and periodic attribute features of taxi scenario.

A surface dynamic interpretable similarity calculation and taxi time prediction module, the surface dynamic interpretable similarity calculation and taxi time prediction module is used to input data integration and calculate the dynamic interpretable similarity between the target scenario and the historical running scenario.

The invention provides an airport surface taxi time prediction method and system based on interpretable similarity. There are many ways and means to realize the technical scheme. The above is only the preferred implementation method of the invention. It should be pointed out that for ordinary technical personnel in the technical field, some improvements and embellishments can be made without breaking away from the principle of the invention. These improvements and embellishments should also be regarded as the protection scope of the invention. Each component that is not clearly defined in this embodiment can be implemented using existing technology.

What is claimed is:

1. A method of minimizing airport taxi time, comprising the following steps:
Step 1, surface original data processing, collecting airport scenario data from an A-CDM system and airport weather data from an aviation meteorological department, preprocessing the obtained data to obtain a complete data list without missing items in line with an actual operation, and constructing a candidate scenario database;
Step 2, establishing a surface taxi scenario feature system, starting from flight model data, flight plan data, surface situation data and airport environment data, extracting a feature related to taxi time and classifying according to whether the data has a periodic property, dividing a result into a static feature similarity of taxi scenario and a periodic feature similarity of taxi scenario, and carrying out a data construction, respectively;
Step 3, dynamic similarity calculation and taxi time prediction, calculating a taxi time according to the dynamic interpretable similarity, calculating a scenario similarity between a target scenario and the candidate similar scenario according to the static feature and the periodic feature, and performing a weighted sum to obtain an integrated scenario similarity, according to the obtained scenario similarity, weighting a taxi time of all candidate scenarios to linearly generate a taxi time prediction result in the target scenario;
Step 4, input dynamic interpretable similarity patterns in an airport collaborative decision-making (A-CDM) system to allow airport personnel to minimize airport taxi times.

2. The method of minimizing airport taxi time according to claim 1, wherein Step 1 specifically comprises:
(1.1) collecting collaborative decision-making data from the airport A-CDM system, flight plan data from airlines, and meteorological message data from the airport meteorological department, and matching the data involved in all flight scenarios;
(1.2) preprocessing matched data, removing all erroneous data, completing missing data, screening out all abnormal data, and constructing an original scenario database.

3. The method of minimizing airport taxi time according to claim 1, wherein Step 2 comprises:
(2.1) based on an original data set of the taxi scenario generated by screening, extracting static attribute features of the taxi scenario, the static attribute features of taxi scenario include eight common features, namely flight number, airline, runway apron group, parking space, aircraft type, destination airport, hour and minute, a taxiing trajectory is reflected by the pairing of runway and parking space, the above eight features are classified features, so an entity embedding method is introduced for recoding, constructing a neural network with a taxi time in different scenarios as a supervision condition, and adding an additional embedding layer to the network, embedding classification features in all samples into half of an original dimension;
(2.2) the content reflected by the periodic attribute features of the taxi scenario is an interaction relationship between a departure flight and other departure or arrival flight and the weather, four types of eight surface traffic features based on a spatio-temporal network topology are adopted, which comprehensively considers a possible relationship between departure flights and arrival flights, the departure/arrival surface instantaneous flow index (SIFI) denotes a count of arrival or departure aircrafts that are taxiing when the target aircraft is launched; the departure/arrival surface cumulative flow index (SCFI) denotes a count of departure and arrival aircrafts that are also in a taxiing state when the target aircraft taxis, the aircraft queue length index (AQLI) denotes a total number of the aircraft taking off or landing during the taxiing of the target aircraft; the slot resource demand index (SRDI) is used to represent a total number of aircraft launched or landed within 15 minutes before and after a launch time of the target aircraft;
(2.3) constructing a data structure required by an input network, according to the features of the two types of data, in the construction of the static attribute feature data structure of the taxi scenario, a vector for data embedding processing is called the static attribute vector gᵢ, and all the sample target scenarios are stacked with their respective candidate similar scenario sets for input structure construction, the final input data format is s×n×2×α_{cat}, where S denotes a count of sample scenarios, α_{cat} is a dimension of the static attribute vector after processing, and n is a count of candidate scenarios, the flight static attributes of all sample target scenarios are compared with those of each candidate similar scenario in this type of construction, the above attributes are only related to the flight plan or the airport and weather data and have nothing to do with the actual state of the airport surface;
(2.4) in terms of the periodic attribute features of taxi scenarios, considering that an arrangement of flight schedules may have periodic features, splicing the dynamic attribute features of the environment also of the first day, the first 7 days and the first 28 days of all scenarios to form a multi-time scale environment dynamic attribute input vector under one day, which is called dynamic attribute vector gₑ, and all scenario data is processed according to the above steps, all scenarios are combined with their respective candidate similar scenario sets, and finally the input data is formed.

4. The method of minimizing airport taxi time according to claim 3, wherein in Step (2.2), the estimated launch time and planned take-off time are used in the calculation of these features, considering post-launch and tactical operations.

5. The method of minimizing airport taxi time according to claim 1, wherein Step 3 specifically comprises:
(3.1) scenario index decomposition, for the taxi time T(n) in the n-th candidate similar scenario, the deviation δₙ between the taxi time T_{ξ} of the target scenario ξ and the deviation between the first candidate similar scenario and the target scenario is used for representation, therefore, the following method is used to model and analyze the composition of the departure taxi time of the candidate similar scenario:
$$T ( n ) = {T}_{ξ} + {δ}_{n}$$
various influencing factors and uncertainties involved in the surface will lead to the shortening or prolongation of the taxi time in the current scenario compared with the target scenario, therefore, in order to facilitate the analysis, the taxi time deviation in the n-th candidate scenario is subject to the normal distribution of the mean value of 0, so δₙ□N(0,
$${σ}_{n}^{2} ) ,$$
where
$${σ}_{n}^{2}$$
is the variance due to the key feature difference between the target scenario and it under the condition of the scenario;
(3.2) suppose there are only two different departure flight operation scenarios i and j in a scenario, the taxi time is rewritten as T(i) □Nᵢ(T_{ξ},
$${σ}_{i}^{2} ) ,$$
and the other sample is rewritten as T(j) □Nⱼ(T_{ξ},
$${σ}_{j}^{2} ) ;$$
multiple samples with the same mean but different variances are used for combination, and weights are applied to minimize the overall variance to obtain a more accurate value T_{ξ}:
$${T}_{ξ}^{E} = {ω}_{i} {N}_{i} + {ω}_{j} {N}_{j}$$
where ω is the scenario similarity,
$${T}_{ξ}^{E}$$
is an estimated value of the target scenario taxi time, the sum of the similarities is limited to ωᵢ+ωⱼ=1;
(3.3) the variance of T_{ξ} is
$$D ( {T}_{ξ}^{E} )$$
according to statistical knowledge, and:
$$D ( {T}_{ξ}^{E} ) = {ω}_{i}^{2} {σ}_{i}^{2} + {ω}_{j}^{2} {σ}_{j}^{2} = {ω}_{i}^{2} {σ}_{i}^{2} + {( 1 - {ω}_{i} )}^{2} {σ}_{j}^{2}$$
the similarities in the formula are derived to obtain:
$$\begin{matrix}\frac{d ( D ( {T}_{ξ}^{E} ) )}{d {ω}_{i}} = 2 {ω}_{i} ( {σ}_{i}^{2} + {σ}_{j}^{2} ) - 2 {σ}_{j}^{2} \\ \frac{{d}^{2} ( D ( {T}_{ξ}^{E} ) )}{d {ω}_{i}^{2}} = 2 {ω}_{i} ( {σ}_{i}^{2} + {σ}_{j}^{2} )\end{matrix}$$
obviously, a value of a second derivative is greater than zero, so a minimum value of the variance is obtained, and corresponding similarities are:
$$\begin{matrix}{ω}_{i} = \frac{{σ}_{j}^{2}}{{σ}_{i}^{2} + {σ}_{j}^{2}} \\ {ω}_{j} = \frac{{σ}_{i}^{2}}{{σ}_{i}^{2} + {σ}_{j}^{2}}\end{matrix}$$
if the corresponding similarities of multiple scenarios are determined, the expression is as follows:
$${ω}_{i} = \frac{{\prod }_{k ∈ S - i} {σ}_{k}^{2}}{{\sum }_{l = 1}^{n} {\prod }_{o ∈ S - l} {σ}_{o}^{2}}$$
where S is a set of scenarios, including n different scenarios, so the following results are obtained:
$${T}_{ξ}^{E} = {\sum }_{i ∈ S} {ω}_{i} {N}_{i}$$
where a sum of all similarities is 1, that is
$${\sum }_{i ∈ S} {ω}_{i} = 1 ;$$
(3.4) also considering a sample variance is a minimum value, combined with a final prediction result, it is approximately considered that the taxi time of the target scenario is a weighted sum of the samples, and it is expressed as:
$${T}_{ξ} = {\sum }_{i ∈ S} {ω}_{i} T ( i )$$
likewise, a similarity sum is 1, that is,
$${\sum }_{i ∈ S} {ω}_{i} = 1 ,$$
where each weight ωᵢ is the interpretable similarity of the scenario;
based on the features of interpretable similarity, the processed two types of data are input into two neural networks NET1 and NET2 respectively, the calculation process is as follows:
(3.5) data downsampling visualization, using a convolution kernel to downsample the data; expanding the simplified data to form a two-dimensional tensor, the size and shape are similar to those of common pictures;
(3.6) class image convolution, using a LeNet-based network framework structure to perform convolution pooling on a tensor, connecting the fully connected layers to the ends of the two neural networks to obtain their similarity vectors, and combining the weights to obtain a similarity fitting result of n×1, the number is consistent with the number of candidate similar scenarios, wherein a loss function is calculated as follows:
$$ω = {arg min}_{{ω}_{mn}} ( \frac{1}{K} {\sum }_{{x}_{m}^{ξ} ∈ α} {( {\sum }_{{x}_{n} ∈ β} {ω}_{mn} T ( {x}_{n} ) - T ( {x}_{m}^{ξ} ) )}^{2} + λ {\sum }_{{x}_{m}^{ξ} ∈ α} {\sum }_{{x}_{n} ∈ β} {{ω}_{mn} ( T ( {x}_{n} ) - T ( {x}_{m}^{ξ} ) )}^{2} )$$
where ω is a similarity set of candidate similar scenarios in all target scenarios, ωₘₙ is the similarity of the n-th scenario in the m-th target scenario, the meaning of xₘ^{ξ} is the m-th target scenario feature, the meaning of xₙ is the n-th historical scenario feature, α is the target scenario set, β is the candidate similar scenario set, λ is a deviation importance parameter, K is the count of target running scenarios for all departure aircraft in the training process, T(xₙ) is the taxi time of the n-th candidate similar scenario, and
$$T ( {x}_{m}^{ξ} )$$
is actual taxi time in the target scenario
$${x}_{m}^{ξ} ;$$
the loss function is composed of two parts, which minimizes the taxi time prediction error on the training set and reduces the similarity value of the high deviation scenario also the actual function of the neural network in this process is to calculate the similarity between different scenarios and the target scenario and use it to linearly generate the taxi time of the departure flight in the target scenario;
(3.7) prior processing, finally, in order to ensure that the similarity sum is 1, the following conditions are required:
$${\sum }_{n ∈ N} {ω}_{n} = 1 ω \geq 0 ;$$
based on this constraint, it is necessary to perform additional prior processing on the similarity of the outputs in the two neural networks, firstly, all the negative similarities of the outputs need to be mapped to 0, that is, adding an additional ReLU layer at the end of the two neural networks; secondly, the ownership weight needs to be normalized, that is, adding a normalized layer after the ReLU layer of the two neural networks, combined weighting and outputting the above similarity to generate the overall similarity between the target scenario and the candidate similar scenario the calculation method is as follows:
$$μ {\sum }_{n ∈ N} {ω}_{n}^{net 1} + ( 1 - μ ) {\sum }_{n ∈ N} {ω}_{n}^{net 2} = 1 , ω {>}_{0 ¯} O$$
where μ is a combination similarity distribution coefficient,
$${ω}_{n}^{net 1} and {ω}_{n}^{net 2}$$
are the static and dynamic vector similarities of the candidate similar scenarios output by NET1 and NET2 in the n-th sample target scenario respectively;
(3.8) iterative training and similarity extraction, by linearly generating the taxi time, linearly weighting and summing the predicted combined similarity and the historical taxi time in the candidate similar scenario, and performing an iterative training according to the loss function to reduce the error between the combined similarity and the historical taxi time;
(3.9) according to the calculation results of scenario similarity, weighting and summing the taxi time of the corresponding flight in each candidate similar scenario, and the result is used to represent the taxi time result in the target scenario.

6. A system for minimizing airport taxi time, comprising:
an airport surface flight taxi scenario data processing module, wherein the airport surface flight taxi scenario data processing module is used to collect and preprocess data from multiple data sources;
a surface flight taxi scenario feature extraction and grouping module, wherein the surface flight taxi scenario feature extraction and grouping module extracts features according to whether the data has periodic features, and divides the results into static attribute features of taxi scenario and periodic attribute features of taxi scenario;
a surface dynamic interpretable similarity calculation and taxi time prediction module, wherein the surface dynamic interpretable similarity calculation and taxi time prediction module is used to input data integration and calculate the dynamic interpretable similarity between the target scenario and the historical running scenario.
